(19) United States
(12) Patent Application Publication
(10) Pub. No.: US 2011/0268916 A1
(43) Pub. Date: Nov. 3, 2011

(54) Double Skin Composite Hybrid Structural Insulated Panel

(76) Inventor: Johnny Roger Pardue, JR., Philadelphia, MS (US)

(21) Appl. No.: 13/050,089

(22) Filed: Mar. 17, 2011

Related U.S. Application Data
(60) Provisional application No. 61/343,572, filed on Apr. 30, 2010.

(51) Int. Cl. B32B 3/12; B32B 27/38; B32B 27/40; B32B 27/00; B32B 9/04; B32B 27/36; B32B 17/06; B32B 19/00; B32B 29/00; B32B 3/26; B32B 27/30

(52) U.S. Cl. 428/116; 428/304.4; 428/413; 428/423.1; 428/500; 428/522; 428/480; 428/426; 428/688; 428/532; 428/411.1

(57) ABSTRACT

The invention is a structural insulated panel that can be utilized as a building panel. The structural insulated panel has a two part skin system, comprising a semi-flexible or rigid FRP laminate that is adhered to a thicker and usually more rigid material such as cement board or magnesium oxide board. The double skin is adhered to one or both sides of a core material that can comprise one or more plastic foams, natural materials, honeycomb, paper, plastic and aluminum.

### CROSS-REFERENCE TO RELATED APPLICATIONS

This application claims the benefit of U.S. Provisional Application No. 61/343,572 filed on Mar. 19, 2010.

### STATEMENT REGARDING FEDERALLY SPONSORED RESEARCH

None.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to structural insulated panels and methods of manufacturing such panels. In particular, the present invention relates to such panels that have an inner core layer and one or more outer laminate layers.

B. Background

Structural insulated panels have been in use for some time as a primary building material. The advantages of these panels (commonly referred to as SIPs) is their high strength to weight ratios, high ultimate strength, excellent insulation values and labor saving construction techniques.

SIPs are made from various materials to achieve specific performance criteria, common SIP materials include cores made from plastic foams, such as expanded polystyrene, extruded polystyrene, and Urethanes such as polyisosyanate and polyisocyanurate foams.

The cores typically are non-structural, and ridged or flexible “skins” are attached to one or both sides of the core. The most common “skin” material is oriented strand board, or OSB, also popular are metal, such as steel and aluminum. In addition cement board, and cement reinforced OSB sheets are also used. A new material also in frequent use as “skins” is magnesium oxide board, and calcium silicate board. Additionally fiber reinforced plastic (known as FRP) is also utilized, primarily in the sun room and recreational vehicle markets.

Each of these “skin” materials has to be adhered permanently to the core material in order for a panel to have structural integrity. Common methods to accomplish this are glue bonding and pressing, injecting or pouring liquid foam.

The various “skin” materials each have strengths and weaknesses, as example OSB is cost effective and available in large (8×24 foot) sizes, and is quite strong as a “skin” material, its weaknesses however are flammability, attack by insects and vulnerability to moisture. OSB SIPS usually require sheet rock application on the interior to comply with fire codes, and some type of weather resistant siding on the exterior.

Steel and aluminum are light in weight and non flammable; however they do not protect the core from heat and also may require sheetrock to comply with fire codes. Metal “skins” also dent easily and may require cosmetic finishes.

Cement board, magnesium oxide and calcium silicate boards resist fire, insulate the core from heat, and can be finished with only paint or stucco, these type of materials have good structural properties in the axial compressive area, however exhibit poor performance in flexural loads, and are heavy and brittle and difficult to handle in the field. Another disadvantage is that these types of “skins” are relatively small, being 4 feet wide and only as long as 12 feet, thus requiring these types of SIP panels to be smaller than OSB SIP panels. This results in more labor, and less strong structures due to the many joints.

FRP “skins” are light in weight, impervious to moisture and insects and can be made fire proof. FRP laminates can be made from a wide variety of reinforcing materials including but not limited to glass (woven, non-woven, stitched) polypropylene, carbon fiber, arimid, Kevlar, spectra, vectran, nylon, polyamide and high modulus polyester, and even natural material such as flax, hemp and kanaf.

FRP is made by combining plastics with the aforementioned reinforcing fibers. The plastics are primarily two types of systems, thermoset resins, and thermoplastics. The thermoset resins are typically a two part system consisting of the resin and a hardener or catalyst. These resins can be but are not limited to polyester, vinyl ester, phenolic, epoxy, polyurethane, urethane, and soy based resin. The thermoplastics are applied to the reinforcement in a molten state; various types of plastics are used in this process including but not limited to: polyethylene, polypropylene, polyvinylchloride, polycarbonate, polyamide, nylon, polystyrene, and polybutylene.

FRP is engineered for low or high performance. Good flexural strength is one of the properties of some FRP. Weaknesses include possible flammability, low compressive and racking shear and the inability to protect the core material from heat, thus requiring a layer of sheetrock to meet fire codes. FRP “skins” are also very thin and most require some sort of exterior finish. Panels made from these materials sound hollow when pounded on and transmit a good bit of sound; a heavy rain is very loud to occupants of structures built from FRP SIPs.

Until the invention there was not a SIP panel which performed well in most or all areas, and builders are forced to compromise, and add steps and extra time and materials to the construction process to achieve a high quality, properly finished structure.

### SUMMARY OF THE INVENTION

The invention is a Double Skin Composite Hybrid Structural Insulated Panel.

The invention is a building panel which employs a two part skin system, which is comprised of semi-flexible or rigid FRP laminate, adhered to a thicker and usually more rigid material such as cement board, or magnesium oxide board. The double skin is adhered to one or both sides of a core material, which is typically made from a plastic foam or honeycomb. Natural material such as hemp or kanaf can also be used as a core material.

The double skin(s) utilizing FRP laminates on one or both sides of the core material is unique to the invention which is designed for high strength, moisture resistance, fire resistance impact resistance and easy cosmetic finishing. Ballistic resistance can also be part of the design. The panels can be made from to small to very large sizes and can utilize various types of FRP inner skin(s) and various outer skin materials, as well as various core materials. The invented panels outperform panels made out of a single skin material. The invention is a vast improvement over SIPs manufactured by conventional methods and materials, and saves construction labor, time and materials.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

FIG. 1 is a cross section of the SIP;

FIG. 2 is a perspective view of a 10 by 32 foot SIP;

FIG. 3 is close up cross section of the SIP;

FIG. 4 is a perspective view of the SIP detailing staggered outer skins;

FIG. 5 is a perspective view of the SIP detailing a simulated brick outer skin;

FIG. 6 is a close up cross section of the SIP detailing the use on only 1 outer skin;

FIG. 7 is a close up cross section of the SIP detailing the use on only 1 inner skin;

FIG. 8 is a view of SIPS made with a plank siding material, intended to be stacked together on top of each other; and

FIG. 9 is a cross section of the SIP in FIG. 8 detailing how SIPs are stacked on top of each other.

### DETAILED DESCRIPTION OF THE INVENTION

The invention is a Double Skin Composite Hybrid Structural Insulated Panel

The invention is a building panel which employs a two part skin system, which is comprised of semi-flexible or rigid FRP laminate, adhered to a thicker and usually more rigid cementitious or non-cementitious sheathing board type material. The double skins(s) are adhered to one or both sides of a core material.

The invention utilizes cores made from plastic foams, such as expanded polystyrene, extruded polystyrene, and Urethanes such as polyisosyanate and polyisocyanurate foams. Phenolic foam, polyvinylchloride foam soy base foam, and other systems could also be substituted. Additionally a core material employing a honeycomb material can be used; such a core can be insulated with foam or left un-insulated in certain applications. Honeycomb materials include plastics, paper and aluminum. Another option for core materials are natural materials such as hemp, straw, and kanaf.

The invention is not a panel with sheetrock or cement board simply nailed or screwed on to it on a building site, the invention is an engineered panel which is bonded together in a manufacturing facility with strict quality controls. (should I take this out?)

The invention utilizes the double skin system to overcome weaknesses of individual skin materials, while exploiting the strengths of each individual material. The invented panels are superior in many ways to panels currently commercially available.

The double skin(s) utilizing FRP laminates on one or both sides of the core material is unique to the invention which is designed for high strength, moisture resistance, fire resistance and easy cosmetic finishing. The panels can be made from small to very large sizes and can utilize various types of FRP inner skin(s) and various outer skin materials, as well as various core materials. The invented panels outperform panels made out of a single skin material.

The double skin system in the invention consists of inner skin(s) of Fiber Reinforced Plastic or Fiber Reinforced Polymer (FRP). FRP laminates can be made from a wide variety of reinforcing materials including but not limited to: glass (woven, non-woven, stitched and chopped, and mats) polypropylene, carbon fiber, arimid, kevlar, spectra, vectran, nylon, polyamide, and high modulus polyester and natural material such as flax, hemp and kanaf.

FRP is made by combining plastics with the aforementioned reinforcing fibers. The plastics are primarily two types of systems, thermoset resins, and thermoplastics.

The thermoset resins are typically two part systems consisting of the resin and a hardener or catalyst. These resins can be but are not limited to polyester, vinyl ester, phenolic, urethane, epoxy and soy based resin. An example of thermo set FRP is a phenolic/fiberglass laminate made by DuraSip, LLC of Union Mississippi. There are many commercially available FRP laminates made by many manufacturers suitable for use in the invention.

The thermoplastic systems are applied to the reinforcement in a molten state; various types of plastics are used in this process, including but not limited to: polyethylene, polypropylene, polyvinylchloride, polycarbonate, nylon, polyamide, polystyrene, and polybutylene. An example of thermoplastic FRP is “Cosmolite” which is distributed by Tekmodo of Elkhart Ind.

In the invention, any type of FRP can be used to meet the performance criteria of a desired panel.

The double skin system also employs an outer skin which is affixed to the inner FRP skin; the skins are either bonded together with adhesive (liquid or film) or other chemicals, heat bonded, pressure bonded, or bonded with a wet layup of the FRP directly onto the outer skin. The most common application is adhesive bonding.

The outer skin(s) can be made from many different materials to achieve the desired panel properties including, but not limited to: fiber cement board and cement board such as Hardie Panel, and Hardie Plank and Hardie Shingle (by James Hardie Corp.), Smart Side (by Louisiana Pacific Corp.), Dura Rock (by US gypsum Corp.) and other branded and non branded products. Additionally, a profiled cement board with the look and feel of natural materials such as stone and brick can be used, examples are, but are not limited to Color Max (by Certainteed Corp.) and fiber cement panels by Nichia Corp.

A relatively new material to the US market is Magnesium Oxide board; this type of board is sold as Dragon Board, Magnum Board, and Magnesia Core and Gemtree Board, and other branded and non branded names, these types of MGO Board products can be used effectively in the invention as an outer skin material. Another acceptable outer skin material is Calcium Silicate board.

The double skin(s) are affixed to one or both sides of the core material, the skins are either bonded with adhesive (liquid or film) or other chemicals, heat bonded, pressure bonded, or bonded with a wet layup of the FRP directly onto the core material. The most common application is adhesive bonding.

Alternatively liquid plastic foam such as a urethane or phenolic system can be poured or injected between the two pairs of double skins, or one double skin and a single skin, thus forming the core, and bonding to the skins at the same time. This method can be either a continuous or discontinuous process.

The double skins can be the same or completely different on each side of the finished panel. An example might be a smooth surfaced MGO board on the interior of a structure and simulated brick surface Nichia fiber cement board on the exterior of a structure. Alternatively only one side of a panel could receive a double skin; with the other side made from a single skin of FRP, OSB, plywood, plastic, wood, sheetrock, metal or other material, or left without a skin.

The invention is a unique building product with many advantages over the current state of the art of SIP manufacturing. The strength of the combination of the two materials can be engineered to pass most if not all residential and commercial building codes; examples include the ICC AC-04 acceptance criteria for panel construction, Miami Dade County wind codes, National Fire Codes, and California seismic codes.

The high flexural strength of the FRP allows long spans and heavy loading of the panels that could not be achieved with a single rigid board type of skin. The invented panels could be used in many applications, including but not limited to: walls, floors, roofs, Foundations, Basements, Fences, Sound Walls, Commercial, Industrial, Agricultural, Disaster Relief, and military.

An additional benefit of the invention is the ability to manufacture very large panels. Typically the materials used as the outer skin in the invention are only 4 feet wide and up to 12 feet tall, however the FRP laminates used as the inner skins are available in widths, of up to 10 feet and in coils over 600 feet long, this enables the production of 10 foot wide panels by any practical, transportable length. This is a great benefit in commercial “tilt up” panel construction. The largest commercially available conventional OSB SIP is only 8 by 24 feet.

Also the FRP inner skin acts as both a moisture and vapor barrier, and can be made out of fire proof materials such as phenolic resin if desired.

The inner FRP skin can also be made for impact and ballistic resistance.

Another useful application of the invention is panels made using fiber cement plank siding as outer skins; these panels are small (8 inches wide by up to 12 feet long) and can be stacked to build walls and fences.

Clearly the invention is a unique and commercially viable product, with a potential worldwide application.

The drawings show different views and different material combinations of the invention.

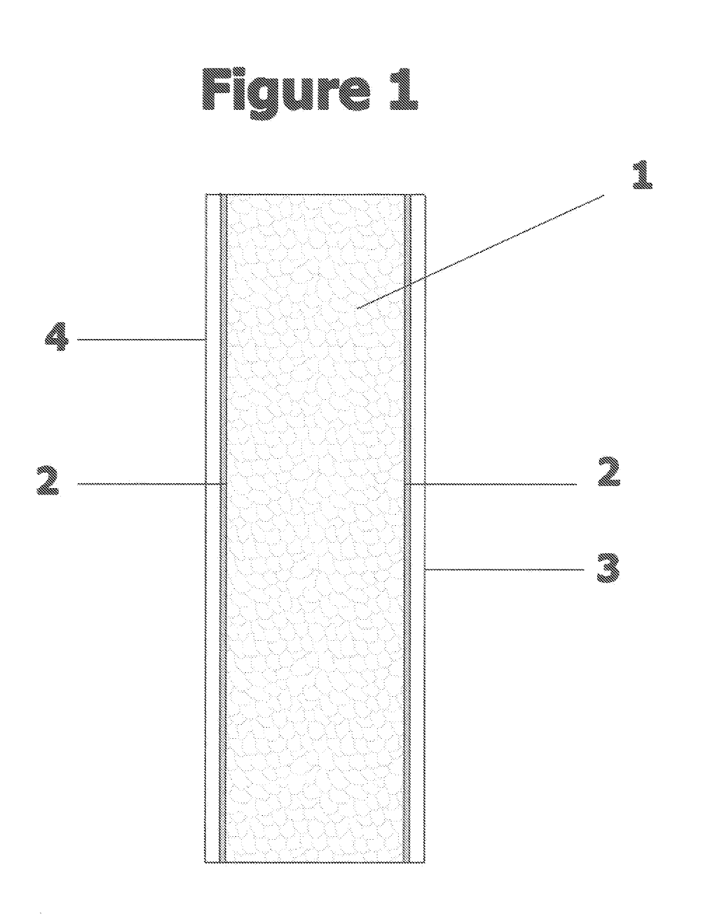

FIG. 1 is a cross section view of the SIP, 1 being the core material. 2 is the FRP inner skin. 3 and 4 are the outer skins the outer skins can be comprised of the same or different combinations of materials.

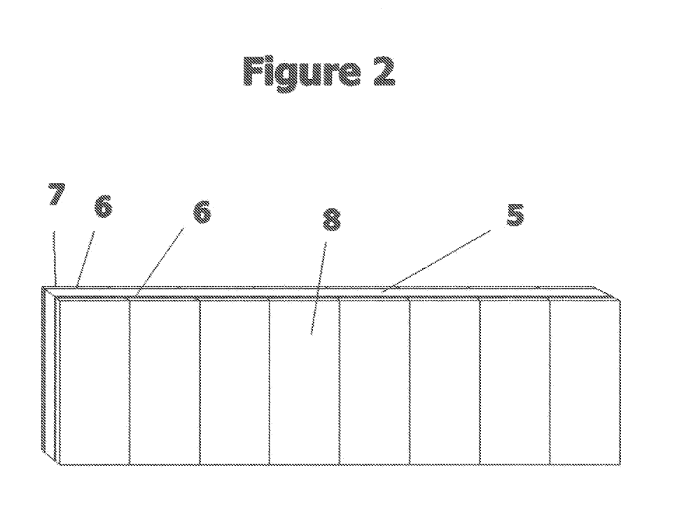

FIG. 2 is a perspective view of a large 10 by 32 foot SIP. 5 is the core. 6 are the inner skins. 7 and 8 are the outer skins.

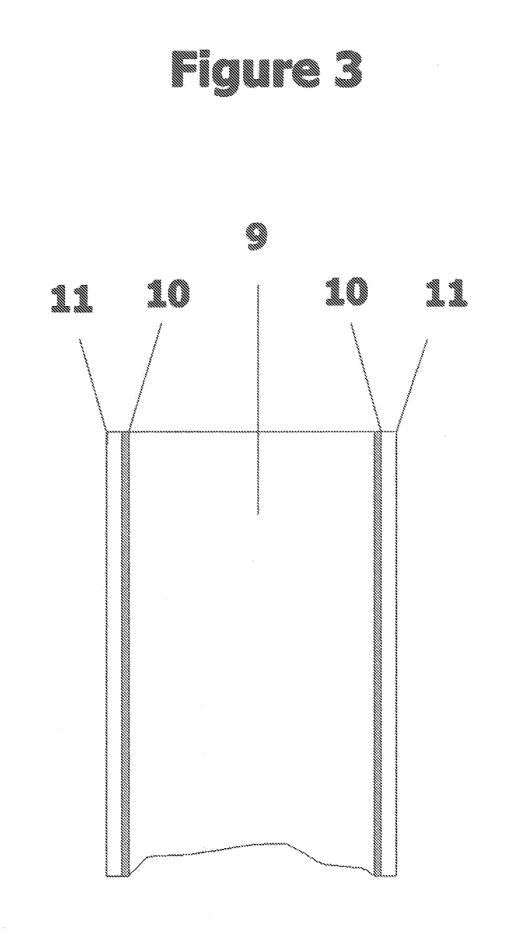

FIG. 3 is a close up cross section showing the buildup of the SIP. 9 is the core material. 10 are the inner skins. 11 are the outer skins. This multi layer construction makes the SIP much stronger than Sips made out of a single skin method.

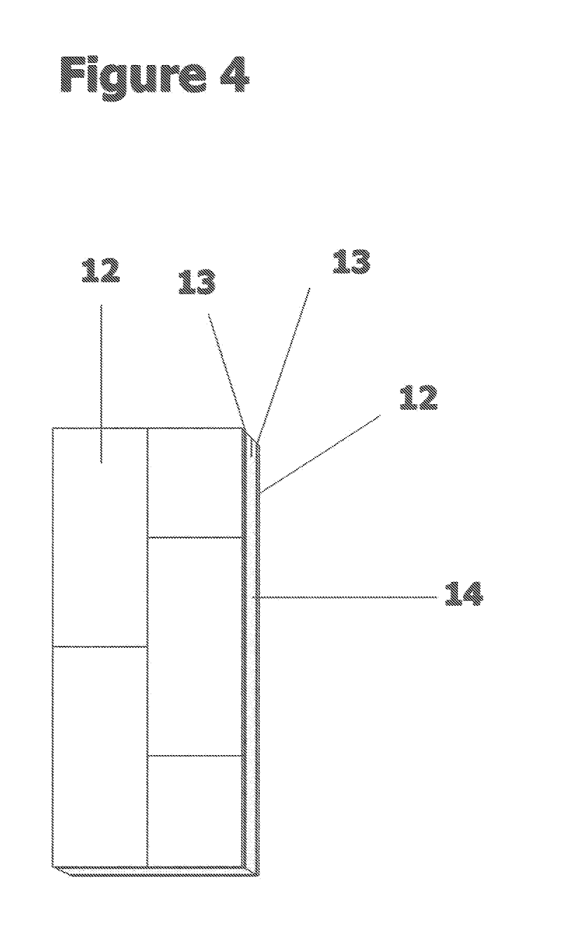

FIG. 4 is another perspective view detailing the ability to stagger the joints of the outer skin(s) due to the continuous FRP inner skin(s) 12 are the outer skin(s). 13 are the inner skin(s). 14 is the core.

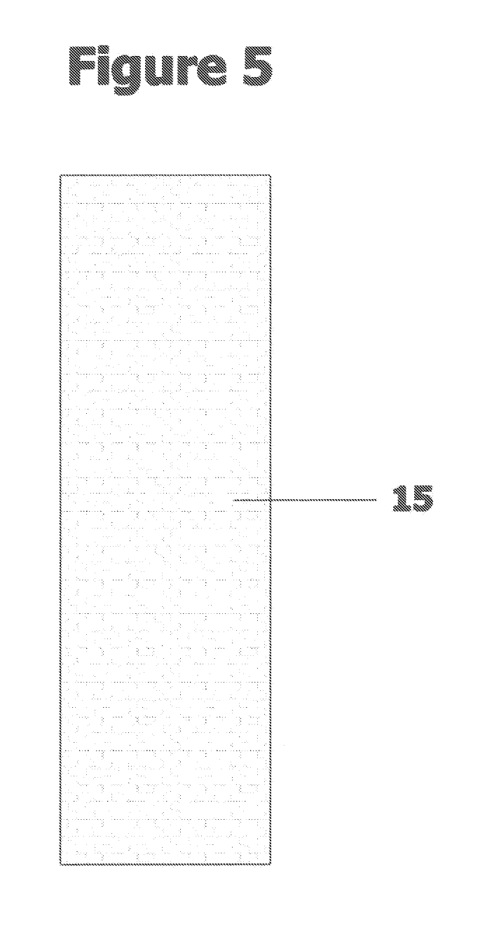

FIG. 5 is a perspective view showing the ability to use a simulated brick, stone or wood cement board as one or both of the outer skins. 15 is the outer skin comprised of simulated brick cement board. These cement boards are typically only 2 by 4 feet, and the continuous FRP inner skin allows for their application onto a large panel at ground level in a fabrication shop, thus saving job site labor and avoiding weather delays.

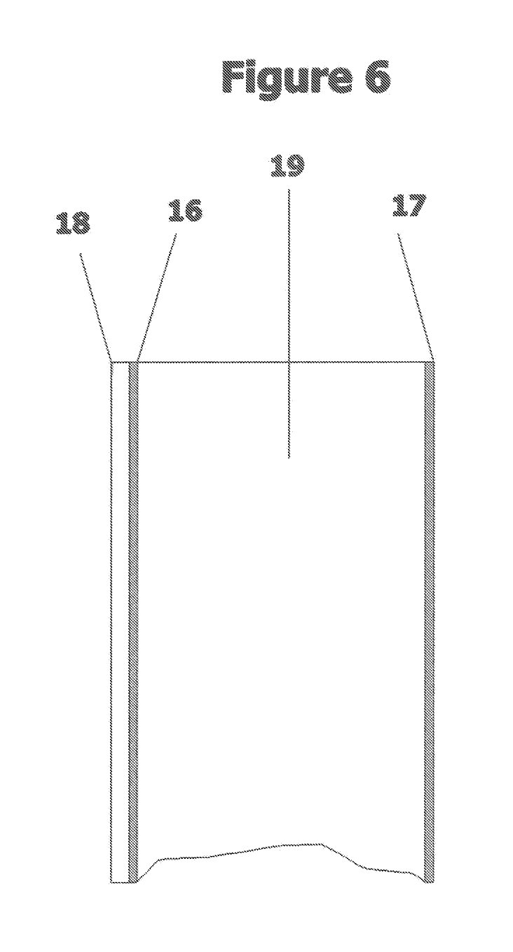

FIG. 6 is a cross section detailing the use of only one outer skin; this application could be used when the FRP is the desired finish surface such as in a food processing facility. 16 is an inner skin. 17 is the exposed inner skin. 18 is the outer skin. 19 is the core.

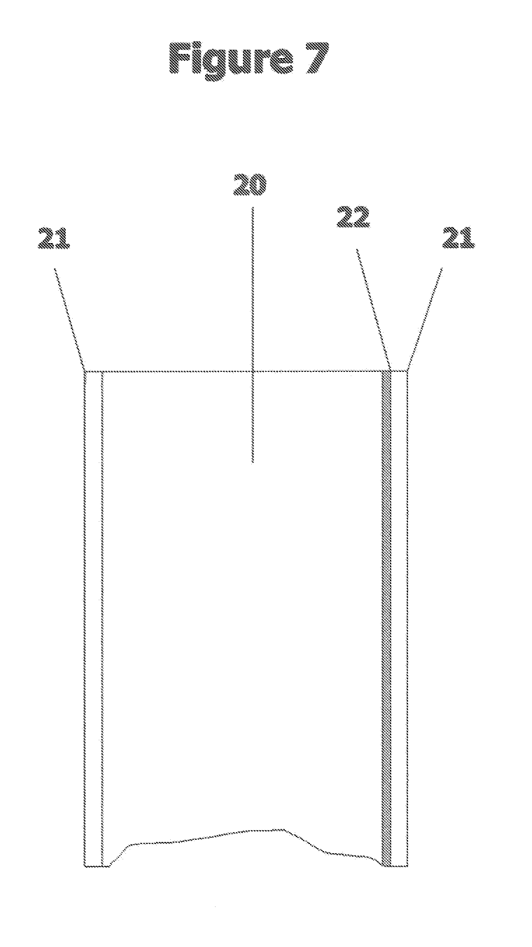

FIG. 7 is a cross section detailing the use of only 1 inner skin, this application may be used where extreme strength is not required, and save on the cost of the unnecessary second inner skin. 20 is the core. 21 are the outer skins (similar or dissimilar). 22 is the single inner skin.

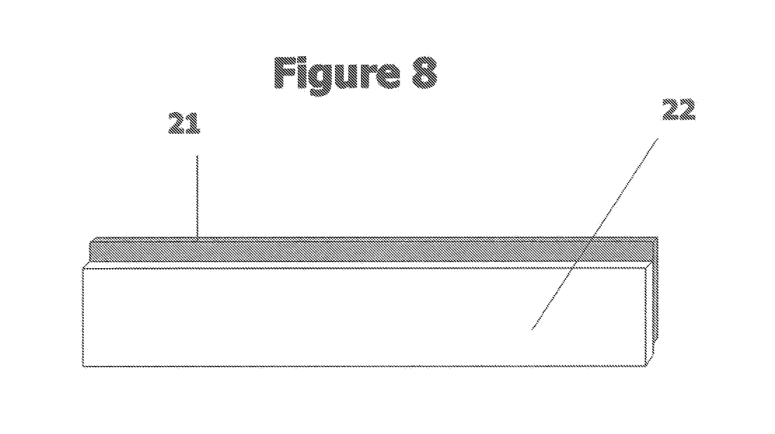

FIG. 8 is a front view of a unique SIP made with cement board siding as outer skin(s) this system can be stacked up for use a easy to build wall or fence system. 22 is the outer skin. 21 is the inner skin.

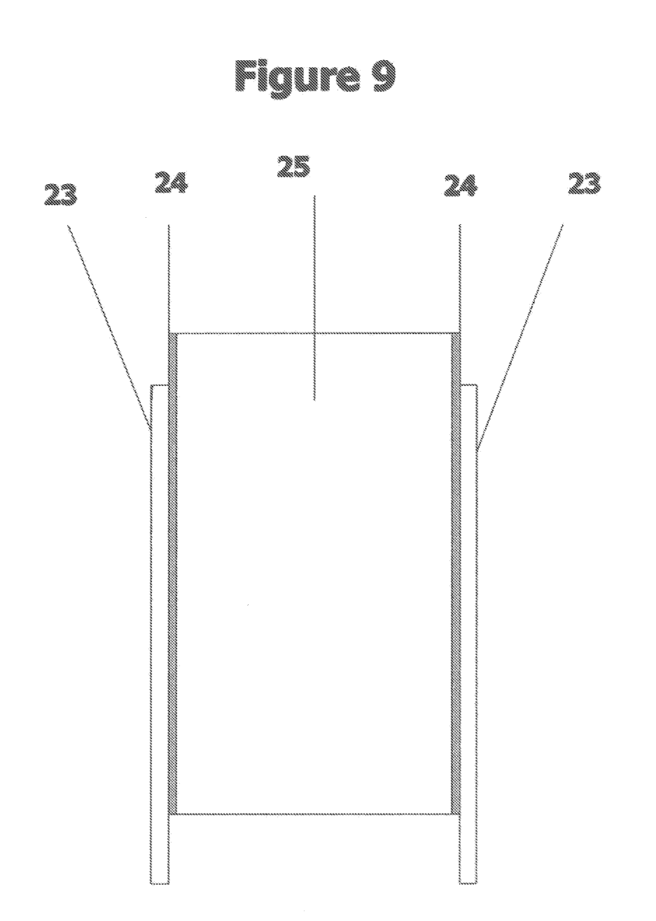

FIG. 9 is the same SIP in FIG. 8 but a cross section view detailing the inner skin and core being offset from the outer skins to facilitate stacking. 23 are the outer skins. 24 are the inner skins. 25 is the core.

The unique properties of the invention allow for many combinations of materials to achieve the desired structural, insulation and cosmetic requirements, required for different building projects.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to various modification with regard to any dimensional relationships set forth herein and modifications in assembly, materials, size, shape and use. For instance, there are numerous components described herein that can be replaced with equivalent functioning components to accomplish the objectives of the present invention.

What I claim as my invention is:

1. A structural insulated panel, comprising:
one or two double outer skins, said double skin(s) comprising a combination of fiber reinforced plastic and a cementitious or non-cementitious sheathing board material; and
an inner core combined with said one or two double outer skins.

2. The structural insulated panel according to claim 1, wherein said core comprises one or more plastic foam materials.

3. The structural insulated panel according to claim 2, wherein said one or more plastic foam materials comprises at least one of: expanded polystyrene foam, extruded polystyrene foam, polyurethane foam, phenolic foam and soy based foam.

4. The structural insulated panel according to claim 1, wherein said core material comprises one or more natural materials.

5. The structural insulated panel according to claim 4, wherein said one or more natural materials comprises at least one of: hemp, hemcrete, kanaf and straw.

6. The structural insulated panel according to claim 1, wherein said core material comprises at least one of: honeycomb, paper, plastic and aluminum.

7. The structural insulated panel according to claim 1, wherein at least one part of said double skin(s) comprises one or more fiber reinforced thermoset plastic resins.

8. The structural insulated panel according to claim 7, wherein said fiber reinforced thermoset plastic resins comprises at least one of: phenolic resin, polyester resin, vinyl ester resin, epoxy resin, polyurethane resin and soy based resin.

9. The structural insulated panel according to claim 1, wherein at least one part of said double skin(s) comprises one or more reinforced thermo plastics.

10. The structural insulated panel according to claim 9, wherein said reinforced thermo plastics comprises at least one of: polyethylene, polypropylene, polyvinylchloride, polycarbonate, polyamide, nylon, polystyrene and polybutylene.

11. The structural insulated panel according to claim 1, wherein one part of said double skin(s) comprises one or more reinforcing fibers.

12. The structural insulated panel according to claim 11, wherein said reinforcing fibers comprises at least one of: fiberglass, kevlar, arimid, spectra, carbon fiber, polypropylene, polyamide, nylon, polyester, high modulus polyester, vectran, hemp, kanaf and flax.

13. The structural insulated panel according to claim 1, wherein one part of said double skin(s) comprises one or more sheathing type boards.

14. The structural insulated panel of claim 13, wherein said sheathing type boards comprises at least one of: cement board, fiber cement board, magnesium oxide board and calcium silicate board.
